(19) United States
(12) Patent Application Publication
(10) Pub. No.: US 2007/0015649 A1
(43) Pub. Date: Jan. 18, 2007

(54) Flow folder apparatus and methods

(75) Inventors: William C. Badalucco, Elkhorn, NE (US); Bruce A. Bennett, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FIRST DATA CORPORATION, Englewood, CO (US)

(21) Appl. No.: 11/183,176

(22) Filed: Jul. 14, 2005

(51) Int. Cl. B31F 1/00

(52) U.S. Cl. 493/431

(57) ABSTRACT

Sheet processing systems and methods for folding sheets are provided. Sheet folder systems include conveyor rollers, drive rollers, drive belts, and spliceable conveyor belts for advancing sheets along a sheet processing path having a receiving zone for receiving the sheet and a folding zone for folding the sheet. Sheets can be folded with various folding means. Methods of constructing sheet folder systems are also provided.

### CROSS-REFERENCES TO RELATED APPLICATIONS

This application is related to U.S. patent application Ser. No. 10/029,122, filed Dec. 21, 2001, now U.S. Pat. No. 6,623,415 (Attorney Docket No. 020375-006300US); Ser. No. 10/045,589, filed Nov. 8, 2001, now U.S. Pat. No. 6,802,500 (Attorney Docket No. 020375-001700US); Ser. No. 10/915,167, filed Aug. 9, 2004 (Attorney Docket No. 020375-001710US); Ser. No. 10/036,653, filed Nov. 8, 2001, now U.S. Pat. No. 6,670,569 (Attorney Docket No. 020375-001800US); Ser. No. 10/731,189, filed Dec. 8, 2003 (Attorney Docket No. 020375-001810US); Ser. No. 10/028,449, filed Dec. 19, 2001, now U.S. Pat. No. 6,779,319 (Attorney Docket No. 020375 006400US); each of which is assigned to the assignee of the instant application and each of which is herein incorporated by reference.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to the field of sheet processing systems and methods, and more particularly to systems and methods for moving sheets through a sheet folding system.

Financial institutions, long distance telephone companies, and a number of other organizations frequently send paperwork to existing or potential customers. For example, a credit card customer may receive monthly statements, informational inserts, sheets of convenience checks, and the like. In some circumstances, the paperwork accompanies a card, such as a credit card or the like, mounted in or to a card carrier. In order to send the paperwork and/or card to a customer, the information may be sent first to a third party organization for processing and mailing. One such organization is First Data Merchant Services Corporation (FDMS).

Mail processing systems are currently used to mail, for example, presentation instruments such as cards to a customer. Such systems typically will affix a card to a carrier sheet, and then fold the sheet to fit into an envelope. The high volume of mailings, however, makes this an expensive process. Sheet processing modules used in these systems are often prone to malfunction due to component breakdown. For example, drive belts and conveyor belts used in existing folding machines may suffer from or be susceptible to unwanted breakage. These failures can be costly, due to hours of machine downtime, expensive replacement parts and associate repair labor, and lost operator time. Moreover, known systems may include drive and conveyor belt configurations that are difficult to repair when breakdowns do occur. Relatedly, existing folding systems often do not create consistently accurate folds.

In light of the above, it would be desirable to provide improved sheet processing systems and methods, particularly for use with mail processing machine components such as sheet folders, and the like.

### BRIEF SUMMARY OF THE INVENTION

The present invention provides sheet processing methods and systems that can be used with customer documents such as credit card carrier sheets. These techniques may be particularly useful in preventing or reducing the frequency of unwanted system failures. Advantageously, the present invention provides sheet folding systems having highly reliable drive belt and conveyor belt configurations for long-lasting operation times with minimal repairs. Moreover, these improved configurations allow for easy and quick repair when required, and provide accurate document folds on a consistent basis.

In a first aspect the present invention provides a sheet folder system. The sheet folder system can include a plurality of conveyor rollers coupled with a support means, a drive roller coupled with a drive motor, a spliceable conveyor belt circumferentially wrapped around the plurality of conveyor rollers and the drive roller such that rotation of the drive roller causes rotation of the conveyor belt about the plurality of conveyor rollers and the drive roller, a sheet processing path that includes a receiving zone configured to receive a sheet and a folding zone downstream from the receiving zone, and a folder assembly disposed at the folding zone. At least a portion of the sheet processing path can be defined by at least a portion of the spliceable conveyor belt. In some aspects, the drive pulley of the drive motor can be coupled with the drive roller via a drive belt. Relatedly, the drive belt can be disposed outside of the sheet processing path. The drive roller can include a tooth rim, the drive pulley can include a tooth pulley, and the drive belt can include a tooth belt configured to transmit force from the tooth pulley to the tooth rim. The drive roller can include a drive roller friction rim, at least one of the plurality of conveyor rollers can include a conveyor roller friction rim, and the conveyor belt can include a friction belt configured to transmit force from the drive roller friction rim to the conveyor roller friction rim. In some aspects, the folder assembly includes a folder blade. The sheet folder system may also include a wheel grip disposed at the sheet processing path. Similarly, the system may have a sheet guide disposed at the sheet processing path. In related embodiments, the system includes a conveyor belt tensioner in cooperative association with the conveyor belt, and a drive belt tensioner in cooperative association with the drive belt.

In a second aspect, the present invention provides a method of constructing a sheet folder system. The method can include coupling a plurality of conveyor rollers with a support means, coupling a drive roller with a drive motor, wrapping a spliceable conveyor belt round the plurality of conveyor rollers and the drive roller such that rotation of the drive roller causes rotation of the conveyor belt about the plurality of conveyor rollers and the drive roller, providing a sheet processing path that includes a receiving zone configured to receive a sheet and a folding zone downstream from the receiving zone, and providing a folder assembly at the folding zone. At least a portion of the sheet processing path may be defined by at least a portion of the spliceable conveyor belt. In some aspects, the method may also include coupling a drive pulley of the drive motor with the drive roller via a drive belt. Similarly, the method may include placing the drive belt outside of the sheet processing path. In some embodiments, the method can include coupling a set of teeth of the drive belt with a tooth pulley of the drive motor and a tooth rim of the drive roller, and in related embodiments, the method can include coupling a friction surface of the conveyor belt with a friction rim of the drive roller and a friction rim of at least one of the plurality of conveyor rollers. The method may also include providing a folder blade at the folding zone, providing a wheel grip at the sheet processing path, and/or providing a sheet guide at the sheet processing path. In some aspects, the method may include contacting the conveyor belt with a conveyor belt tensioner, and contacting the drive belt with a drive belt tensioner.

In another aspect, the present invention provides a method of folding a sheet. The method can include rotating a drive roller with a drive motor, where the drive roller in cooperative association with a spliceable conveyor belt such that rotation of the drive roller causes rotation of the conveyor belt about the drive roller and a plurality of conveyor rollers, placing the sheet at a first end of a sheet processing path, advancing the sheet from a first end of the sheet processing path through a folding zone having a folder blade, and folding the sheet with the folder blade as the sheet is advanced through the folding zone. In a related aspect, the method can also include contacting a friction surface of the conveyor belt with a friction rim of at least one of the plurality of conveyor rollers and a friction rim of the guide roller.

### BRIEF DESCRIPTION OF THE DRAWINGS

FIG. 1 is a simplified schematic of a sheet folding system according to one embodiment of the present invention.

FIGS. 2 and 3 show known sheet folder modules.

FIGS. 4A and 4B show sheet folder modules according to embodiments of the present invention.

FIG. 5 illustrates a sheet folder module according to one embodiment of the present invention.

FIG. 6 illustrates a sheet folder module according to one embodiment of the present invention.

FIG. 7 illustrates a sheet folding process according to one embodiment of the present invention.

### DETAILED DESCRIPTION OF THE INVENTION

The present invention provides systems and methods for advancing customer documents and the like through sheet processing modules such as sheet folders. For example, a sheet folder can have a plurality of conveyor rollers, a spliceable conveyor belt, a drive roller, and a sheet processing path that includes receiving zone and a folding zone. A customer document can be fed into the receiving zone, and then advanced through the folding zone where the system creates a fold in the document. Drive belt and conveyor belt configurations of the present invention can prevent or reduce the frequency of unwanted breakdowns. When breakdowns do occur, repairs for these systems are easier, quicker, and less expensive than repairs for conventional systems. Moreover, sheet processing systems and methods of the present invention can consistently and reliably position customer documents in a folder or other sheet processing module.

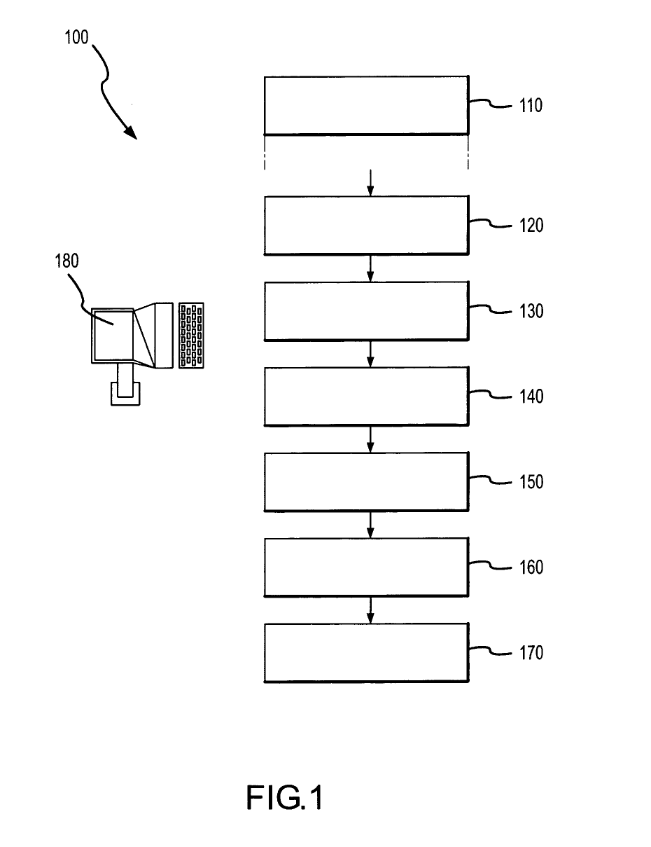

FIG. 1 depicts a simplified schematic of a sheet folding system 100 according to one embodiment of the present invention. System 100 includes a series of stations or modules adapted to produce a folded sheet ready to be inserted into an envelope for mailing. Documents or sheets processed by system 100 can include one or more sheets of paper, such as a customer billing statement, a new cardholder agreement, convenience checks, and the like. Documents also may include a variety of paper inserts, such as advertisements and the like, which require folding. Often, these documents will be affixed with a presentation instrument, such as a card.

System 100 can include a paper source 110, which may include or be coupled with a printer for printing customer documents. The printer may print, for example, alphanumeric characters to identify the customer, the customer's address, the customer's billing information, and the like. The printer further may print bar codes and other identifying marks on the documents.

First folder 120 performs a first fold on the paper sheet. The folded paper sheet is transferred to a bar code reader 130 which can read a bar code that is printed on the sheet. The sheet is then transferred to card attacher 140 where a presentation instrument such as a card is affixed to the sheet. Thereafter, the sheet is processed through a diverter 150, and then to a flow folder 160 which performs a second fold on the paper sheet. The sheet is then transferred to a conveyor 170 for further downstream processing. System 100 can be controlled by a controller 180, which is operative association with the other components of system 100.

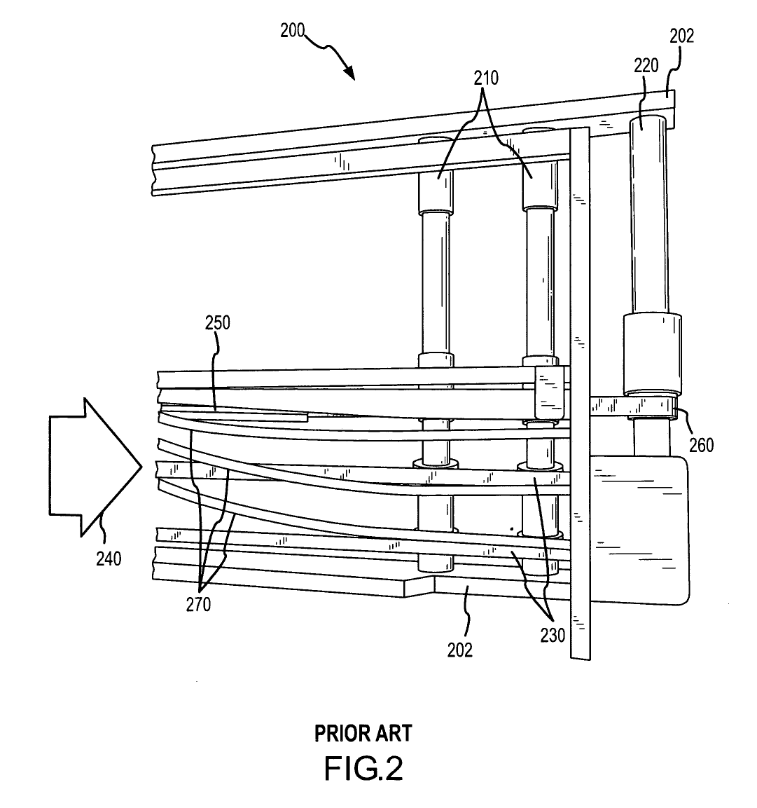

FIG. 2 illustrates a known sheet folder module 200, which includes a plurality of conveyor rollers 210 and a drive roller 220 coupled with a support means 202 or frame. Module 200 further includes two toothed conveyor belts 230 and a toothed drive belt 260, which are disposed along a sheet processing path 240, a folder assembly 250, and a guide assembly 270. The dimensions of belts 230 and 260 and their corresponding belt rims are sized in standard metric units. In this configuration, sheet processing path 240 is defined in part by one active belt (drive belt) and two passive belts (conveyor belts). Drive roller 220 is configured to transmit force from drive belt 260 to conveyor belts 230, and drive belt 260 in cooperation with conveyor belts 230 operate to advance a sheet of paper along sheet processing path 240, and against folder assembly 250 so as to introduce a fold in the sheet of paper. In terms of the system 100 shown in FIG. 1, the folder of the present invention is typically embodied by flow folder 160 to provide a second fold in a sheet, although it is appreciated that the present invention may also be embodied by first folder 120 to provide a first fold in a sheet.

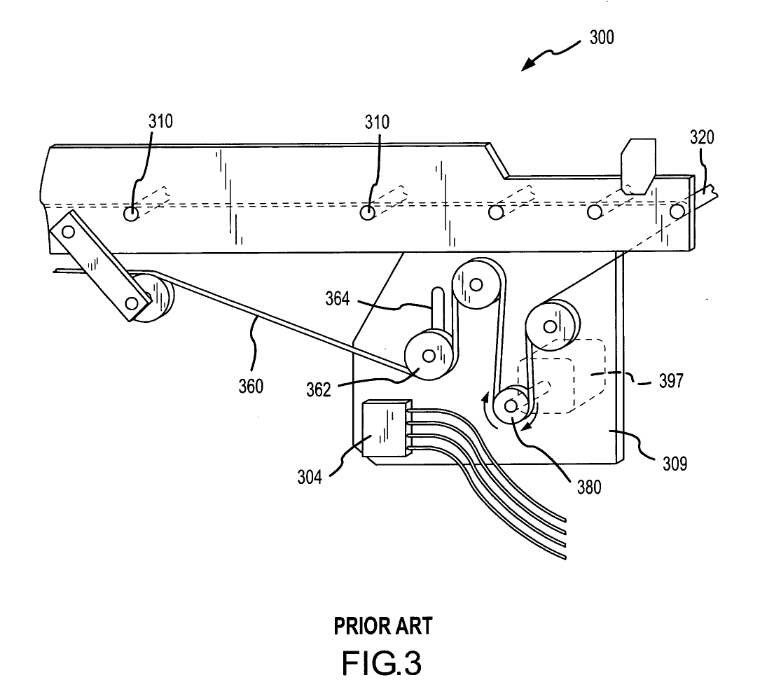

FIG. 3 illustrates a known sheet folder module 300, which includes a plurality of conveyor rollers 310 and a drive roller 320 coupled with a support means 302 or frame. Toothed drive belt 360 travels around the plurality of conveyor rollers 310, the drive roller 320, a drive pulley 380, and a drive belt tensioner pulley 362. Belts may stretch during use. The position of drive belt tensioner pulleys 362 can be adjusted to achieve the desired amount of tension in drive belt 360. For example, the position of drive belt tensioner pulley 362 can be adjusted by setting pulley 362 along various locations of tensioner slot 364. Power assembly 304 provides power to a drive motor 397 which is connected with drive pulley 380. Drive motor 397 and/or pulleys 362, 380 can be coupled with mounting assembly 397.

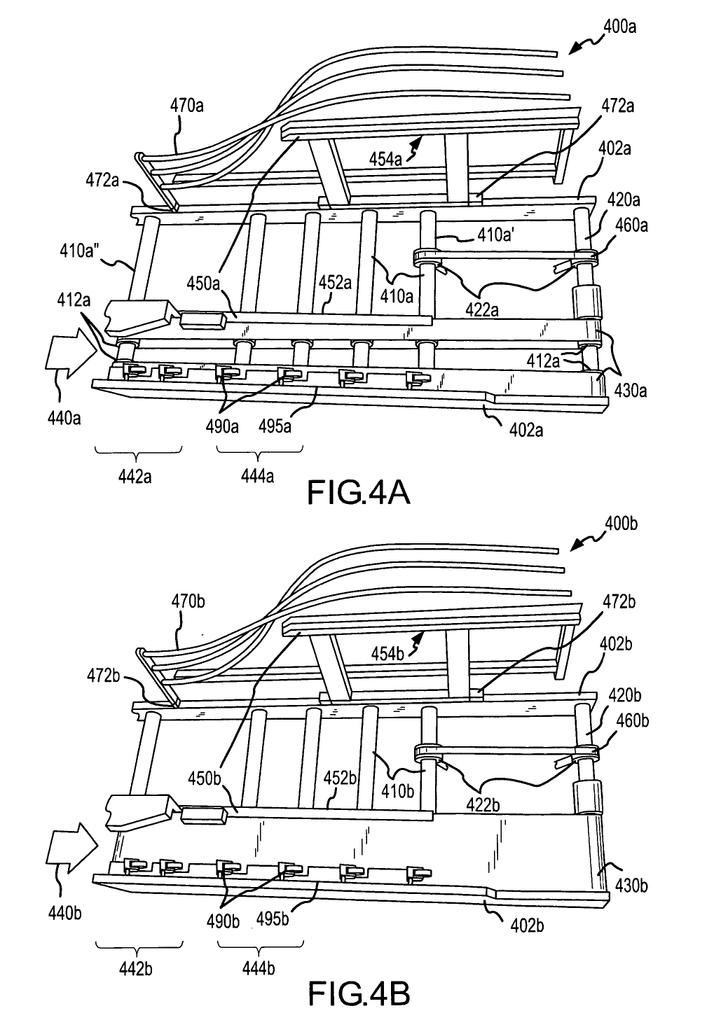

FIG. 4A shows a sheet folder module 400a according to one embodiment of the present invention. Sheet folder module 400a includes a plurality of conveyor rollers 410a and a drive roller 420a coupled with a support means 402a or frame. Module 400a further includes two conveyor belts 430a disposed along a sheet processing path 440a, a drive belt 460a, a folder assembly 450a, and a guide assembly 470a. The dimensions of belts 430a and 460a and their corresponding belt rims can be sized in standard English units. Guide assembly arrangement 472a allows guide assembly 470a to be raised and lowered. As seen here, guide assembly 470a is in a raised position. Prior to operating the module, however, guide assembly 470a is typically placed in a lowered position, as depicted in FIG. 3. Drive belt 460a is disposed outside of sheet processing path 440a, and sheet processing path 440a is defined in part by two conveyor belts 430a, which in many embodiments are passive belts. Although conveyor belts 430a are typically passive belts, it is appreciated that in some embodiments, a conveyor belt 430a can be an active belt in operative association with a drive motor. Similarly, a module can include two active conveyor belts 430a, and each may be coupled with a drive motor. Sheet processing path 440a can include a receiving zone 442a for receiving a sheet of paper from an upstream apparatus such as a translation component. Sheet processing path 440a can also include a folding zone 444a where the folder assembly 450a folds the sheet.

Each of the drive roller 420a and a conveyor roller 410a′ can include a drive belt rim 422a, and each of the drive roller 420a and a conveyor roller 410a″ can include a conveyor belt rim 412a. In operation, drive belt 460a rotates drive roller 420a and/or conveyor roller 410a′ by transmitting force from belt 460a to rims 422a. A rotating drive roller 420a transmits force from drive belt 460a to conveyor belts 430a via conveyor rim 422a, and conveyor belts 430a operate to advance a sheet of paper along sheet processing path 440a. Sheet is contacted with folder assembly 450a so as to introduce a fold in the sheet of paper. Sheet folder module 400a can further include a sheet guide 495a and a wheel grip 490a to assist in aligning the sheet as it travels along sheet processing path 440a.

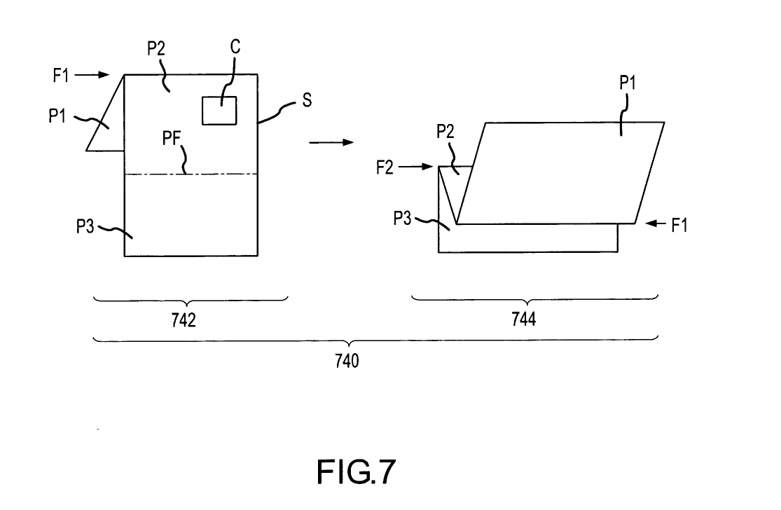

For example, a sheet of paper can be received into receiving zone 442a, such that a fold in the sheet at a first perforation, is disposed beneath wheel grip 490a and aligned against sheet guide 495a. A portion of the sheet can also be disposed beneath bottom fold guide 452. As the sheet of paper is advanced along the sheet processing path 440a, from receiving zone 442a toward folding zone 444a, a fold is created in the sheet at the second perforation due to the top fold guide 454 urging a portion of sheet toward the bottom fold guide 452. Often, bottom fold guide 452 will be a folder blade. This folding process is shown in greater detail in FIG. 7. It has been discovered that in contrast to the conveyor belts used in known systems, which are often about 10 mm wide, the conveyor belts of the present invention are often about 33 mm wide, and therefore provide more contact area with the sheet. Accordingly, it is possible to have more consistent and reliable placement of a sheet of paper as it travels along sheet processing path 440a, thus resulting in a more predictable fold.

In some embodiments, drive belt 460a is a tooth belt, rims 422a are tooth rims, and drive pulley (not shown) is a tooth pulley. For example, drive belt 460a can be a standard toothed 33 inch belt which are commonly available from most belt distributors, such as Goodyear® part number 330XL037. In other embodiments, drive belt 460a is a flat belt, rims 422a are friction rims, and drive pulley (not shown) is a friction pulley. In related embodiments, conveyor belts 430a are tooth belts and conveyor belt rims 412a are tooth belts. Alternatively, conveyor belts 430a can be flat belts and conveyor belt rims 412a can be friction rims. To provide sufficient frictional coupling or grip between a roller or a pulley and a flat belt, a rim or pulley may include any of a variety of textured surfaces. For example, a rim or pulley may include a knurled surface. Such surface features can also assist in maintaining proper tracking of the belt. It has been discovered that flat belts often display longer wear time, and thus require less frequent replacement. Drive belt 420a and conveyor belts 430a can be composed of any of a variety of materials. For example, a belt may include rubber, Kevlar®, polyvinyl chloride (PVC), urethane, various fabrics, and the like.

Conveyor belts 430a can be spliceable by a variety of techniques. Splice types include step splices, finger splices, bevel splices, longitudinal splices, and the like. Similarly, belts may be spliced with staples, laces, rivets, screws, glues, adhesives, fasteners, and the like. In some embodiments, a heating process may be used to create a splice melt. For example, the ends of the belt may be cut an angle so that the belt has the appropriate length needed for wrapping around the rollers and pulley of the module, and internal adhesives contained in the belt can be melted with a heating device to create an angled seam. It has been discovered that spliceable conveyor belts often require less time to replace than non-spliceable conveyor belts, as the replacement procedure may not require the removal of certain components from the module. For example, an operator or repair person can simply string a belt through the module and splice the ends together. Spliceable belts also allow the operator to make any needed adjustments while working at or near the machine, thus providing an accurate belt fitting. The present invention also provides for efficient belt replacement that does not require or involve the removal of other system components, as is the case with many known folder systems. For example, when replacing belts in the present invention, it may not be necessary to remove support means 202 (see FIG. 2) or motor 397 or mounting assembly 309 (see FIG. 3).

It has been discovered that roller and belt configurations such as those described herein allow an operator to realize an improvement in folder durability and a reduction in system failure. For example, when running six folding systems according to the present invention over a period of approximately nine months, the present inventors experienced only one conveyor belt failure. In contrast, when running the same number of known folding systems (such as those described in FIGS. 2 and 3) over a period of approximately twelve months, the present inventors experienced 137 conveyor belt failures.

FIG. 4B illustrates another embodiment of the sheet folder module of the present invention. Sheet folder module 400b includes a plurality of conveyor rollers 410b and a drive roller 420b coupled with a support means 402b or frame. Module 400b further includes a conveyor belt 430b disposed along a sheet processing path 440b, a drive belt 460b, a folder assembly 450b, and a guide assembly 470b. Drive roller 420b is configured to transmit force from drive belt 460b to conveyor belt 430b, and conveyor belt 430b operates to advance a sheet of paper along sheet processing path 440b, and against folder assembly 450b so as to introduce a fold in the sheet of paper.

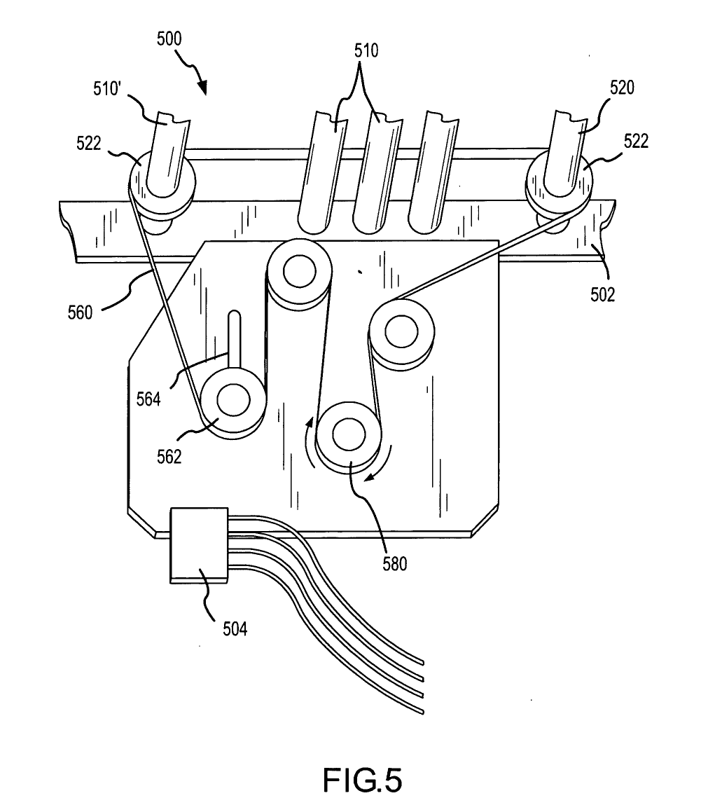

FIG. 5 illustrates another embodiment of the sheet folder module of the present invention. Sheet folder module 1200 includes a plurality of conveyor rollers 510 and a drive roller 520 coupled with a support means 502 or frame. In operation, power assembly 504 provides power to drive motor (not shown) to rotate drive pulley 580, thereby causing drive belt 560 to transmit force to drive belt rim 522 of conveyor roller 510′ and/or drive belt rim 522 of drive roller 520. Belts may stretch during use. The position of drive belt tensioner pulley 562 can be adjusted to achieve the desired amount of tension in drive belt 560. For example, the position of drive belt tensioner pulley 562 can be adjusted by setting pulley 562 along various locations of tensioner slot 564. Power assembly 504 provides power to a drive motor (not shown) which is connected with drive pulley 580. Drive motor causes drive pulley 580 to rotate in the direction shown by the arrows. A conveyor belt is not shown in this figure.

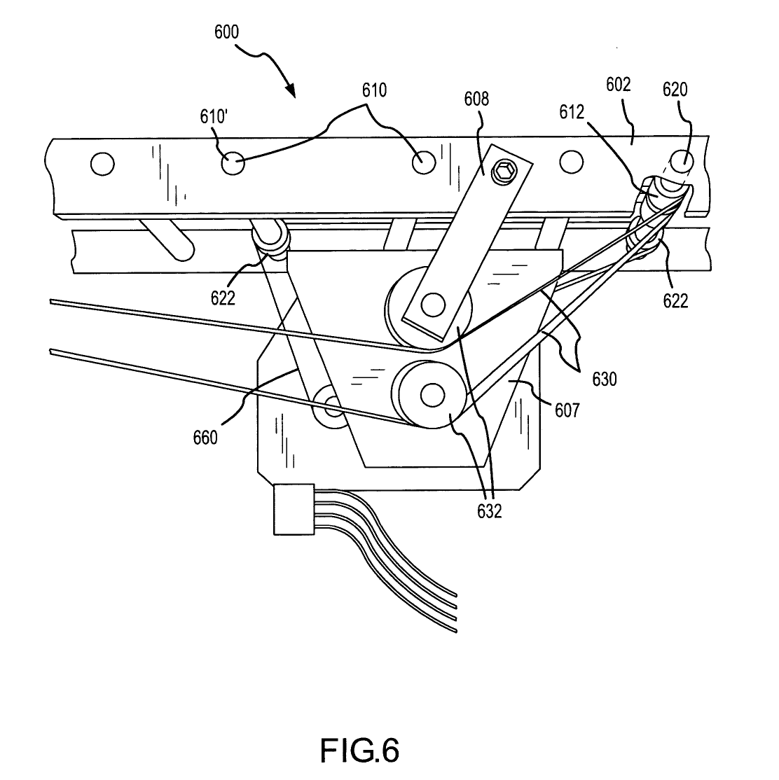

FIG. 6 shows an embodiment of the sheet folder module of the present invention. Sheet folder module 600 includes a plurality of conveyor rollers 610 and a drive roller 620 coupled with a support means 602 or frame. Drive roller 620 is configured to transmit force from drive belt 660 to conveyor belts 630. For example, drive belt 660 rotates drive roller 620 and/or conveyor roller 610′ by transmitting force from belt 660 to rims 622. When rotating, drive roller 620 transmits force to conveyor belts 630 via conveyor rims 612. Conveyor belts 630 operate to advance a sheet of paper along sheet processing path (not shown). Belts may stretch during use. The position of conveyor belt tensioner pulleys 632 can be adjusted to achieve the desired amount of tension in conveyor belts 630. Conveyor belt tensioner pulleys may be mounted on any of a variety of conveyor pulley brackets 607 or conveyor pulley arms 608.

As noted above, the folder modules according to the present invention may be used to create a second fold in a card carrier, after a card has been affixed to the carrier and a first fold in the carrier has been created. FIG. 7 illustrates a sheet folding process according to such an embodiment. Before sheet S enters receiving zone 742 from the left side of sheet processing path 740, card C typically is already affixed with panel two P2 of sheet S, and a first fold F1 is already created in sheet S so that panel one P1 is disposed underneath panel two P2, and panel two P2 is flat and coplanar with panel three P3. Typically, folds occur at perforations in the sheet, so as sheet S is processed through folding zone 744, a second fold F2 is created in sheet S along a perforation PF as panels P1 and P2 are forced up and over panel three P3. As a result, as sheet S is processed in folding zone 744, panel one P1 is disposed on top of panel two P2, which in turn is disposed on top of panel three P3, thus creating a Z-fold. It is appreciated that sheet S can be made of any of a variety of materials, and can be of any of a variety of sizes. For example, sheet S can be a piece of letter size paper. It is further appreciated that the present invention will find use in creating folds other than Z-folds, including, but not limited to, C-folds and other various bi-folds, tri-folds, and the like.

The above provides a full and complete disclosure of certain embodiments of the present invention for purposes of clarity and understanding. However, it will be appreciated that various modifications, alternate constructions, and equivalents may be employed as desired. Therefore, the above description and illustrations should not be construed as limiting the invention, which is defined by the appended claims.

What is claimed is:

1. A sheet folder system, comprising:
a plurality of conveyor rollers coupled with a support means;
a drive roller coupled with a drive motor;
a spliceable conveyor belt circumferentially wrapped around the plurality of conveyor rollers and the drive roller such that rotation of the drive roller causes rotation of the conveyor belt about the plurality of conveyor rollers and the drive roller;
a sheet processing path that includes a receiving zone configured to receive a sheet and a folding zone downstream from the receiving zone; and
a folder assembly disposed at the folding zone;
wherein at least a portion of the sheet processing path is defined by at least a portion of the spliceable conveyor belt.

2. The sheet folder system of claim 1, wherein a drive pulley of the drive motor is coupled with the drive roller via a drive belt.

3. The sheet folder system of claim 2, wherein the drive belt is disposed outside of the sheet processing path.

4. The sheet folder system of claim 2, wherein the drive roller comprises a tooth rim, the drive pulley comprises a tooth pulley, and the drive belt comprises a tooth belt configured to transmit force from the tooth pulley to the tooth rim.

5. The sheet folder system of claim 1, wherein the drive roller comprises a drive roller friction rim, at least one of the plurality of conveyor rollers comprises a conveyor roller friction rim, and the conveyor belt comprises a friction belt configured to transmit force from the drive roller friction rim to the conveyor roller friction rim.

6. The sheet folder system of claim 1, wherein the folder assembly comprises a folder blade.

7. The sheet folder system of claim 1, further comprising a wheel grip disposed at the sheet processing path.

8. The sheet folder system of claim 1, further comprising a sheet guide disposed at the sheet processing path.

9. The sheet folder system of claim 1, further comprising a conveyor belt tensioner in cooperative association with the conveyor belt, and a drive belt tensioner in cooperative association with the drive belt.

10. A method of constructing a sheet folder system, the method comprising:
coupling a plurality of conveyor rollers with a support means;
coupling a drive roller with a drive motor;
wrapping a spliceable conveyor belt round the plurality of conveyor rollers and the drive roller such that rotation of the drive roller causes rotation of the conveyor belt about the plurality of conveyor rollers and the drive roller;
providing a sheet processing path that includes a receiving zone configured to receive a sheet and a folding zone downstream from the receiving zone; and
providing a folder assembly at the folding zone;
wherein at least a portion of the sheet processing path is defined by at least a portion of the spliceable conveyor belt.

11. The method of claim 10, further comprising coupling a drive pulley of the drive motor with the drive roller via a drive belt.

12. The method of claim 11, further comprising placing the drive belt outside of the sheet processing path.

13. The method of claim 11, further comprising coupling a set of teeth of the drive belt with a tooth pulley of the drive motor and a tooth rim of the drive roller.

14. The method of claim 10, further comprising coupling a friction surface of the conveyor belt with a friction rim of the drive roller and a friction rim of at least one of the plurality of conveyor rollers.

15. The method of claim 10, further comprising providing a folder blade at the folding zone.

16. The method of claim 10, further comprising providing a wheel grip at the sheet processing path.

17. The method of claim 10, further comprising providing a sheet guide at the sheet processing path.

18. The method of claim 10, further comprising contacting the conveyor belt with a conveyor belt tensioner, and contacting the drive belt with a drive belt tensioner.

19. A method of folding a sheet, the method comprising:
rotating a drive roller with a drive motor, the drive roller in cooperative association with a spliceable conveyor belt such that rotation of the drive roller causes rotation of the conveyor belt about the drive roller and a plurality of conveyor rollers;
placing the sheet at a first end of a sheet processing path;
advancing the sheet from a first end of the sheet processing path through a folding zone having a folder blade; and
folding the sheet with the folder blade as the sheet is advanced through the folding zone.

20. The method of claim 19, further comprising contacting a friction surface of the conveyor belt with a friction rim of at least one of the plurality of conveyor rollers and a friction rim of the guide roller.
